(19) United States
(12) Patent Application Publication
(10) Pub. No.: US 2022/0150151 A1
(43) Pub. Date: May 12, 2022

(54) METHOD AND SYSTEM FOR MEASURING APPLICATION EXPERIENCE IN REAL TIME

(71) Applicant: MOZARK PTE. LTD.

(72) Inventors: Chandrasekar RAMAMOORTHY, Mumbai (IN); Sourabh CHOWDHURY, Mumbai (IN); Kartik RAJA, Mumbai (IN)

(73) Assignee: MOZARK PTE. LTD., OT (SG)

(21) Appl. No.: 17/094,680

(22) Filed: Nov. 10, 2020

(51) Int. Cl. H04L 12/26; H04L 12/24; H04L 29/08

(52) U.S. Cl. CPC H04L 43/50; H04L 43/12; H04L 67/10; H04L 41/5009; H04L 43/08

(57) ABSTRACT

The present disclosure provides a method and system for measuring application experience using a quality quantification system. The quality quantification system correlates one or more applications, a communication network, and any of datacenter, cloud or content distribution network (CDN) logs. In addition, the quality quantification system receives an active testing data and a passive monitoring data associated with the one or more applications. Further, the quality quantification system collects a technical application data and an application business data associated with the one or more applications. Furthermore, the quality quantification system fetches a user journey data and a user experience data for the one or more applications. Moreover, the quality quantification system analyzes the active testing data, the passive monitoring data, the technical application data, the application business data, the user journey data and the user experience data. Also, the quality quantification system evaluates an application quality index.

### TECHNICAL FIELD

The present invention relates to the technical field of quality metric system, and in particular, relates to a method and system for measuring application experience in real time.

### INTRODUCTION

Over the past few years, applications have become a popular way for end users to perform various activities. The applications include documentation applications, data management applications, financial applications, entertainment applications, educational applications, enterprise applications, simulation applications, media development applications, and the like. In addition, developer of each of the applications require to analyze user experience on respective application. Further, the user experience is dependent of a plurality of factors. The plurality of factors includes networks, content delivery, design, user interface, latency, packet loss, signal strength, and the like. Furthermore, the developer of each of the applications require to analyze the user experience to take corrective measures to improve the user experience. Moreover, the developer of each of the applications loses the end users due to bad user experience. Also, the developer of each of the applications loses revenue due to bad user experience.

### SUMMARY

In a first example, a computer-implemented method is provided. The computer-implemented method for measuring application experience. The computer-implemented method includes a first step to correlate one or more applications, a communication network, and any of datacenter, cloud or content distribution network (CDN) logs in real-time. In addition, the computer-implemented method includes a second step to receive an active testing data and a passive monitoring data associated with each of the one or more applications in real-time. Further, the computer-implemented method includes a third step to collect a technical application data and an application business data associated with each of the one or more applications in real-time. Furthermore, the computer-implemented method includes a fourth step to fetch a user journey data and a user experience data for each of the one or more applications in real-time. Moreover, the computer-implemented method includes a fifth step to analyze the active testing data, the passive monitoring data, the technical application data, the application business data, the user journey data and the user experience data using one or more machine learning algorithms. The analysis is performed based on training of a machine learning model. The analysis is performed in real time. Also, the computer-implemented method includes a sixth step to evaluate an application quality index based on the analysis.

In an embodiment of the present disclosure, the computer-implemented method integrates the active testing data and the passive monitoring data associated with each of the one or more applications to enable the evaluation of the application quality index.

In an embodiment of the present disclosure, the technical application data corresponds to data associated with performance of each of the one or more applications. In addition, the application business data includes application churn rate and drop in engagement. Further, the technical application data and the application business data are a plurality of key performance indicators to evaluate the application quality index of each of the one or more applications. Furthermore, the technical application data is dependent on one or more features. Moreover, the one or more features include load speed, one or more communication devices, operating system, and crash reports. Also, the application business data depends on a plurality of aspects. Also, the plurality of aspects includes session length, average application visits, daily active users, retention rate, and revenue.

In an embodiment of the present disclosure, the computer-implemented method normalizes the plurality of key performance indicators to evaluate the application quality index for each of the one or more applications. In addition, the plurality of key performance indicators is normalized in accordance to quality of the communication network of corresponding user of a plurality of users.

In an embodiment of the present disclosure, the computer-implemented method predicts the application experience based on the quality of the communication network of corresponding user of the plurality of users. In addition, the application experience enables each of a plurality of developers of the one or more applications to initiate suitable actions to enhance the application experience.

In an embodiment of the present disclosure, the computer-implemented method predicts user action based on the application experience to enable each of the plurality of developers of the one or more applications to initiate the suitable actions.

In an embodiment of the present disclosure, the computer-implemented method enables the plurality of developers to analyze the application experience of the plurality of users on the one or more applications. In addition, the application experience depends on a plurality of factors. Further, the plurality of factors includes signal strength, quality, transmission power, handover latency, Inter Radio Access Technologies, and downlink throughput. Furthermore, the plurality of factors includes uplink throughput, latency, packet loss, jitter, web latency of websites, and video latency from user end.

In an embodiment of the present disclosure, the computer-implemented method recommends the suitable actions to the plurality of developers of the one or more applications to enhance the application experience.

In an embodiment of the present disclosure, the computer-implemented method aggregates the technical application data, the application business data, the user journey data and the user experience data based on one or more aspects. In addition, the one or more aspects include application responsiveness, video streaming experience, video quality, audio quality, and transaction performance.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for measuring the application experience using a quality quantification system. The method includes a first step to correlate the one or more applications, the communication network, and any of the datacenter, the cloud or the content distribution network (CDN) logs in real-time. In addition, the method includes a second step to receive the active testing data and the passive monitoring data associated with each of the one or more applications in real-time. Further, the method includes a third step to collect the technical application data and the application business data associated with each of the one or more applications in real-time. Furthermore, the method includes a fourth step to fetch the user journey data and the user experience data for each of the one or more applications in real-time. Moreover, the method includes a fifth step to analyze the active testing data, the passive monitoring data, the technical application data, the application business data, the user journey data and the user experience data using the one or more machine learning algorithms. The analysis is performed based on training of the machine learning model. The analysis is performed in real time. Also, the method includes a sixth step to evaluate the application quality index based on the analysis.

In an embodiment of the present disclosure, the quality quantification system integrates the active testing data and the passive monitoring data associated with each of the one or more applications to enable the evaluation of the application quality index.

In an embodiment of the present disclosure, the technical application data corresponds to data associated with performance of each of the one or more applications. In addition, the application business data includes application churn rate and drop in engagement. Further, the technical application data and the application business data are the plurality of key performance indicators to evaluate the application quality index of each of the one or more applications. Furthermore, the technical application data is dependent on the one or more features. Moreover, the one or more features include load speed, one or more communication devices, operating system, and crash reports. Also, the application business data depends on the plurality of aspects. Also, the plurality of aspects includes session length, average application visits, daily active users, retention rate, and revenue.

In an embodiment of the present disclosure, the quality quantification system normalizes the plurality of key performance indicators to evaluate the application quality index for each of the one or more applications. In addition, the plurality of key performance indicators is normalized in accordance to the quality of the communication network of corresponding user of the plurality of users.

In an embodiment of the present disclosure, the quality quantification system predicts the application experience based on the quality of the communication network of corresponding user of the plurality of users. In addition, the application experience enables each of the plurality of developers of the one or more applications to initiate the suitable actions to enhance the application experience.

In an embodiment of the present disclosure, the quality quantification system predicts the user action based on the application experience to enable each of the plurality of developers of the one or more applications to initiate the suitable actions.

In an embodiment of the present disclosure, the quality quantification system enables the plurality of developers to analyze the application experience of the plurality of users on the one or more applications. In addition, the application experience depends on the plurality of factors. Further, the plurality of factors includes signal strength, quality, transmission power, handover latency, Inter Radio Access Technologies, and downlink throughput. Furthermore, the plurality of factors includes uplink throughput, latency, packet loss, jitter, web latency of websites, and video latency from user end.

In an embodiment of the present disclosure, the quality quantification system recommends the suitable actions to the plurality of developers of the one or more applications to enhance the application experience.

In an embodiment of the present disclosure, the quality quantification system aggregates the technical application data, the application business data, the user journey data and the user experience data based on the one or more aspects. In addition, the one or more aspects include application responsiveness, video streaming experience, video quality, audio quality, and transaction performance.

In a third example, a non-transitory computer-readable storage medium is provided. The non-transitory computer-readable storage medium encodes computer executable instructions that, when executed by at least one processor, performs a method for measuring the application experience. The method includes a first step to correlate the one or more applications, the communication network, and any of the datacenter, the cloud or the content distribution network (CDN) logs in real-time. In addition, the method includes a second step to receive the active testing data and the passive monitoring data associated with each of the one or more applications in real-time. Further, the method includes a third step to collect the technical application data and the application business data associated with each of the one or more applications in real-time. Furthermore, the method includes a fourth step to fetch the user journey data and the user experience data for each of the one or more applications in real-time. Moreover, the method includes a fifth step to analyze the active testing data, the passive monitoring data, the technical application data, the application business data, the user journey data and the user experience data using the one or more machine learning algorithms. The analysis is performed based on training of the machine learning model. The analysis is performed in real time. Also, the method includes a sixth step to evaluate the application quality index based on the analysis.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment for measuring application experience in real-time, in accordance with various embodiments of the present disclosure;

FIG. 2 illustrates a functional architecture of a quality quantification system associated with one or more data sources, in accordance with various embodiments of the present disclosure;

FIGS. 3A and 3B illustrate a flowchart of a method for measuring the application experience in real time, in accordance with various embodiments of the present disclosure; and

FIG. 4 illustrates a block diagram of a computing device, in accordance with various embodiments of the present disclosure.

There may be additional structures described in the description that are not depicted in the drawings, and the absence of such depictions should not be considered as an omission of such design from the specification.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

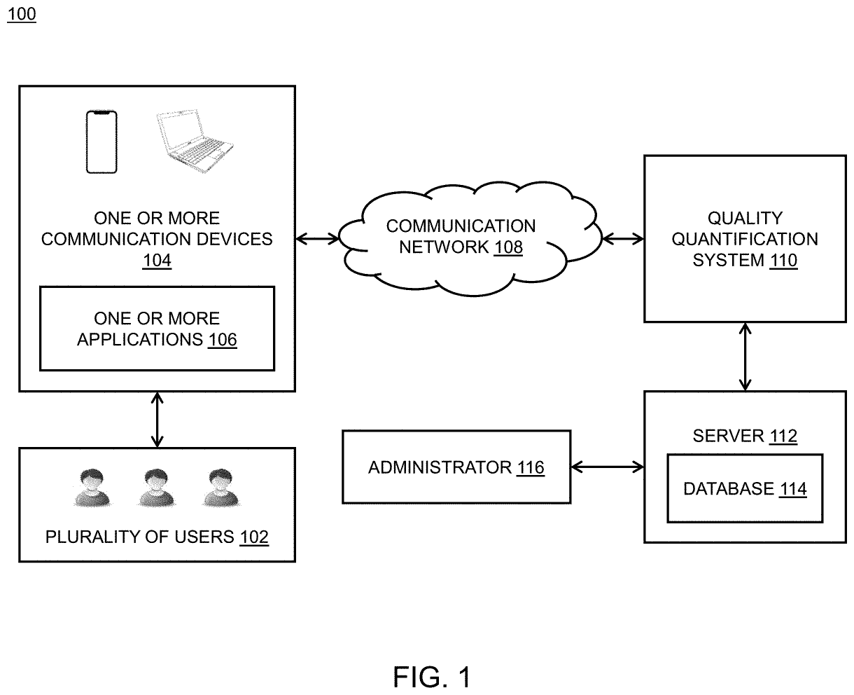

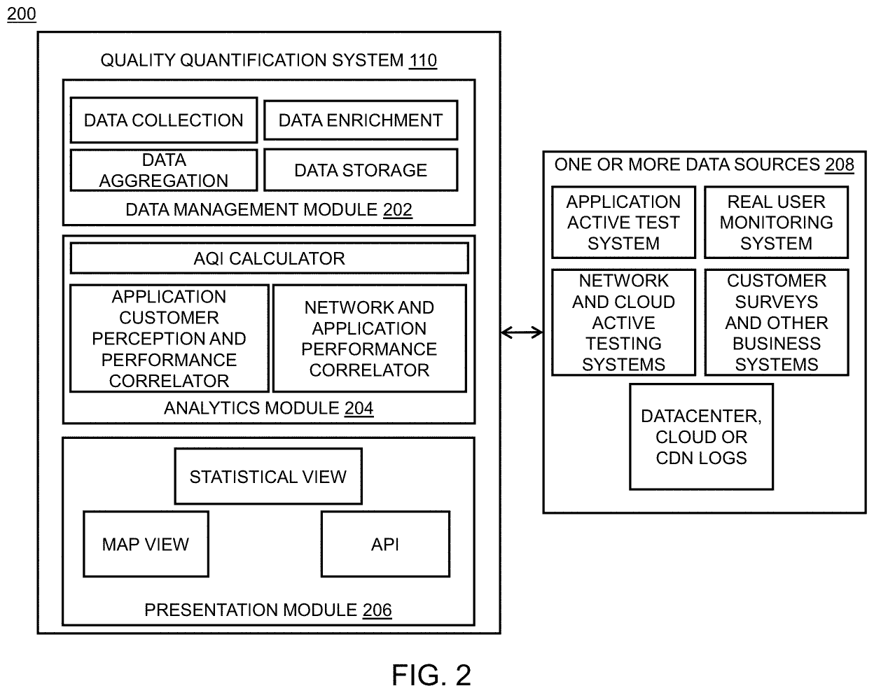

FIG. 1 illustrates an interactive computing environment 100 for measuring application experience in real time, in accordance with various embodiments of the present disclosure. FIG. 2 illustrates a functional architecture 200 of a quality quantification system 110 associated with one or more data sources 208, in accordance with various embodiments of the present disclosure. The interactive computing environment 100 illustrates an environment suitable for integration of data from the one or more data sources 208 to accurately reflect the application experience. The interactive computing environment 100 includes a plurality of users 102, one or more communication devices 104, one or more applications 106, and a communication network 108. In addition, the interactive computing environment 100 includes the quality quantification system 110, a server 112, a database 114 and an administrator 116. The interactive computing environment 100 is any environment facilitating interaction of the plurality of users 102 with the one or more applications 106. The above stated elements of the interactive computing environment 100 operate coherently and synchronously to measure the application experience in real time.

The interactive computing environment 100 includes the plurality of users 102. In addition, the plurality of users 102 may be any person or individual accessing the one or more communication devices 104. In an embodiment of the present disclosure, the plurality of users 102 is an owner of the one or more communication devices 104. In another embodiment of the present disclosure, the plurality of users 102 is not the owner of the one or more communication devices 104. In an embodiment of the present disclosure, the plurality of users 102 accesses the one or more communication devices 104 at home. In another embodiment of the present disclosure, the plurality of users 102 accesses the one or more communication devices 104 at a cafe. In yet another embodiment of the present disclosure, the plurality of users 102 accesses the one or more communication devices 104 in an office. In an example, a user U1 accesses a smartphone S1 while sitting in a living room. In another example, a user U2 accesses a laptop L1 while travelling from one place to another. In yet another example, a user U3 accesses a desktop computer D1 while working in the office.

The interactive computing environment 100 includes the plurality of users 102. The plurality of users 102 corresponds to any number of person or individual associated with the quality quantification system 110. The quality quantification system 110 accesses experience of each of the plurality of users 102 on the one or more applications 106 of the one or more communication devices 104. In an example, a user U1 watches action movie on an application A1 through a communication device D1 (let's say a smartphone). In another example, a user U2 performs financial transaction on an application A2 through a communication device D2 (let's say a desktop computer). In yet another example, a user U3 performs documentation on an application A3 through a communication device D3 (let's say a laptop). The plurality of users 102 accesses the one or more applications 106 on the one or more communication devices 104. In addition, the one or more communication devices 104 are associated with the plurality of users 102.

The interactive computing environment 100 includes the plurality of users 102 who is any person present at any location and accessing the one or more applications 106.

The plurality of users 102 is any legal person or natural person who access the one or more applications 106 and need an IP based network for accessing the one or more applications 106. In addition, the plurality of users 102 is an individual or person who access the one or more applications 106 on the one or more communication devices 104.

The interactive computing environment 100 includes the one or more communication devices 104 that enable the plurality of users 102 to access the one or more applications 106. The one or more communication devices 104 are internet-enabled device to allow the plurality of users 102 to access the one or more applications 106.

In addition, the one or more communication devices 104 facilitate access to the one or more applications 106. In an embodiment of the present disclosure, each of the one or more communication devices 104 is a portable communication device. The portable communication device includes but may not be limited to a laptop, a smartphone, a tablet, and a smart watch. In an example, the smartphone may be an iOS-based smartphone, an android-based smartphone, a windows-based smartphone and the like. In another embodiment of the present disclosure, each of the one or more communication devices 104 is a fixed communication device. The fixed communication device includes but may not be limited to a desktop, a workstation, a smart TV and a mainframe computer.

In an embodiment of the present disclosure, the one or more communication devices 104 are currently in the switched-on state. The one or more communication devices 104 are any type of devices having an active internet. In addition, each of the plurality of users 102 accesses corresponding communication device of the one or more communication devices 104 in real-time.

In an embodiment of the present disclosure, the one or more communication devices 104 perform computing operations based on a suitable operating system installed inside the one or more communication devices 104. In general, the operating system is system software that manages computer hardware and software resources and provides common services for computer programs. In addition, the operating system acts as an interface for software installed inside the one or more communication devices 104 to interact with hardware components of the one or more communication devices 104. In an embodiment of the present disclosure, each of the one or more communication devices 104 perform computing operations based on any suitable operating system designed for the portable communication device. In an example, the operating system installed inside the one or more communication devices 104 is a mobile operating system. Further, the mobile operating system includes but may not be limited to windows operating system, android operating system, iOS operating system, and Sailfish. However, the operating system is not limited to above mentioned operating systems. In an embodiment of the present disclosure, the one or more communication devices 104 operate on any version of particular operating system corresponding to above mentioned operating systems.

In another embodiment of the present disclosure, the one or more communication devices 104 perform computing operations based on any suitable operating system designed for fixed communication device. In an example, the operating system installed inside the one or more communication devices 104 is windows. In another example, the operating system installed inside the one or more communication devices 104 is Mac. In yet another example, the operating system installed inside the one or more communication devices 104 is Linux based operating system. In yet another example, the operating system installed inside the one or more communication devices 104 is Chrome OS. In yet another example, the operating system installed inside the one or more communication devices 104 may be one of UNIX, Kali Linux, and the like. However, the operating system is not limited to above mentioned operating systems.

In an embodiment of the present disclosure, the one or more communication devices 104 operate on any version of windows operating system. In another embodiment of the present disclosure, the one or more communication devices 104 operate on any version of Mac operating system. In yet another embodiment of the present disclosure, the one or more communication devices 104 operate on any version of Linux operating system. In yet another embodiment of the present disclosure, the one or more communication devices 104 operate on any version of Chrome OS. In yet another embodiment of the present disclosure, the one or more communication devices 104 operate on any version of particular operating system corresponding to above mentioned operating systems.

The one or more communication devices 104 enable the plurality of users 102 to access the one or more applications 106. The one or more communication devices 104 are internet-enabled devices that allow the plurality of users 102 to access the one or more interaction platforms 108. In an embodiment of the present disclosure, the one or more applications 106 are installed on the one or more communication devices 104. The one or more applications 106 allow the plurality of users 102 to perform a plurality of activities. In another embodiment of the present disclosure, the one or more applications 106 are run on a plurality of web browsers installed on the one or more communication devices 104. In an example, the plurality of web browsers include but may not be limited to Opera, Mozilla Firefox, Google Chrome, Internet Explorer, Microsoft Edge, Safari and UC Browser. Further, the plurality of web browsers installed on the one or more communication devices 104 runs on any version of the respective web browser of the above mentioned web browsers. In an embodiment of the present disclosure, the plurality of users 102 installs the one or more applications 106 on the one or more communication device 104. In another embodiment of the present disclosure, the plurality of users 102 accesses the one or more applications 106 on the plurality of web browsers installed on the one or more communication devices 104.

In an example, a user U1 connects with the interactive computing environment 100 through a communication device D1 (let's say a smartphone) to run an application A1. In another example, a user U2 connects with the computing environment 100 through a communication device D2 (let's say a desktop computer) at home to perform activities on an application A2. The user U3 connects with the computing environment 100 with a communication device D3 (let's say a tablet) while travelling to access an application A3.

Each of the one or more communication devices 104 comprises of a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processor read data from various entities such as memory or I/O components. The one or more processors execute the one or more instructions which are stored in the memory. The one or more processors provide execution method for one or more instructions provided by the quality quantification system 110.

The one or more communication devices 104 is a media device. The one or more communication devices 104 enable the plurality of users 102 to perform the plurality of activities on the one or more applications 106. The one or more communication devices 104 support various multimedia contents. The plurality of users 102 performs the plurality of activities in real-time through the one or more communication devices 104.

The interactive computing environment 100 includes the one or more applications 106. The one or more applications 106 correspond to program designed for the plurality of users 102 to perform the plurality of activities. The plurality of activities includes streaming, calendaring, scheduling, banking, trading, blogging, mailing, accounting, editing, designing, database management, word processing, simulation, and the like. The plurality of users 102 performs the plurality of activities on the one or more applications 106 through the one or more communication devices 104. In an example, a user U1 watches comedy show C1 on application A1 through a communication device D1 (let's say a smartphone). In another example, a user U2 explores smart watches on application A2 through a communication device D2 (let's say a desktop computer) in real-time. In yet another example, a user U3 reads fiction novel N1 on application A3 through a communication device D3 (let's say a laptop) in real-time.

In an embodiment of the present disclosure, the one or more applications 106 include documentation applications, data management applications, financial applications, and entertainment applications. In another embodiment of the present disclosure, the one or more applications 106 include educational applications, enterprise applications, simulation applications, media development applications, and the like. In addition, the one or more applications 106 are developed by a plurality of developers. Further, the plurality of developers requires analysis of user experience of the plurality of users 102 on the one or more applications 106. Furthermore, the user experience depends on a plurality of factors. Moreover, the plurality of factors includes signal strength, quality, transmission power, handover latency, Inter Radio Access Technologies, downlink throughput, uplink throughput, latency, and packet loss. Also, the plurality of factors includes jitter, web latency of websites, video latency from user end, and the like.

The interactive computing environment 100 includes the communication network 108. The one or more communication devices 104 are connected to the communication network 108. The communication network 108 provides a medium for the plurality of users 102 accessing the one or more applications 102 to connect with the quality quantification system 110. In an embodiment of the present disclosure, the communication network 108 is an internet connection. In another embodiment of the present disclosure, the communication network 108 is a wireless mobile network. In yet another embodiment of the present disclosure, the communication network 108 is a wired network with a finite bandwidth. In yet another embodiment of the present disclosure, the communication network 108 is a combination of the wireless and the wired network for the optimum throughput of data transmission. In yet another embodiment of the present disclosure, the communication network 108 is an optical fiber high bandwidth network that enables a high data rate with negligible connection drops. The communication network 108 includes a set of channels. Each channel of the set of channels supports a finite bandwidth. Moreover, the finite bandwidth of each channel of the set of channels is based on capacity of the communication network 108. The communication network 108 connects the one or more communication devices 104 to the quality quantification system 110 using a plurality of methods. The plurality of methods used to provide network connectivity to the one or more communication devices 104 includes 2G, 3G, 4G, 5G, Wifi and the like.

The interactive computing environment 100 includes the quality quantification system 110. The quality quantification system 110 correlates the one or more applications 106, the communication network 108, and any of datacenter, cloud or content distribution network (CDN) logs in real-time. In addition, the quality quantification system 110 receives an active testing data and a passive monitoring data associated with each of the one or more applications 106 in real-time. Further, the quality quantification system 110 integrates the active testing data and the passive monitoring data associated with each of the one or more applications 106 to enable the evaluation of an application quality index.

The quality quantification system 110 collects a technical application data and an application business data associated with each of the one or more applications 106 in real-time. The technical application data corresponds to data associated with performance of each of the one or more applications 106. The application business data include but may not be limited to application churn rate and drop in engagement. The technical application data and the application business data are a plurality of key performance indicators to evaluate the application quality index of each of the one or more applications 106. The technical application data is dependent on one or more features. The one or more features include but may not be limited to load speed, the one or more communication devices 104, the operating system, and crash reports. The application business data depends on a plurality of aspects. The plurality of aspects include but may not be limited to session length, average application visits, daily active users, application churn rate, retention rate, and revenue.

The quality quantification system 110 associates the technical application data and the application business data in real time to recommend suitable actions to the plurality of developers to enhance the application experience. In addition, the quality quantification system 110 fetches a user journey data and a user experience data for each of the one or more applications 106 in real-time. Further, the quality quantification system 110 enables each of the plurality of users 102 to define user journey and user experience for each of the one or more applications 106. Furthermore, each of the one or more applications 106 has the user journey and the user experience for each of the plurality of users 102.

The quality quantification system 110 aggregates the technical application data, the application business data, the user journey data and the user experience data based on one or more aspects. In addition, the one or more aspects include but may not be limited to application responsiveness, video streaming experience, video quality, audio quality, and transaction performance.

The quality quantification system 110 analyzes the active testing data, the passive monitoring data, the technical application data, the application business data, the user journey data and the user experience data. In addition, the quality quantification system 110 performs the analysis using one or more machine learning algorithms. Further, the analysis is performed based on training of a machine learning model. Furthermore, the analysis is performed in real time. In an embodiment of the present disclosure, the one or more machine learning algorithms include a decision tree algorithm and a random forest algorithm. In another embodiment of the present disclosure, the one or more machine learning algorithms include but may not be limited to prediction algorithms, deep learning algorithms, natural language processing algorithm and the like. However, the one or more machine learning algorithms are not limited to the above-mentioned algorithms.

In addition, the quality quantification system 110 creates the machine learning model to perform the prediction of the application quality index and user action based on the application experience. The machine learning model is trained to identify the plurality of key performance indicators. In an embodiment of the present disclosure, the machine learning model is trained using supervised machine learning model. In another embodiment of the present disclosure, the machine learning model is trained using unsupervised machine learning model. Moreover, the machine learning model predicts behavior of each of the plurality of users 102 based on the user journey.

The quality quantification system 110 normalizes the plurality of key performance indicators to evaluate the application quality index for each of the one or more applications 106. In addition, the plurality of key performance indicators is normalized according to quality of the communication network 108 of corresponding user of the plurality of users 102 that impacts the application experience.

In an embodiment of the present disclosure, the plurality of key performance indicators is normalized for the documentation applications installed on the portable communication device according to the quality of the internet connection. In another embodiment of the present disclosure, the plurality of key performance indicators is normalized for the documentation applications installed on the portable communication device according to the wireless mobile network. In yet another embodiment of the present disclosure, the plurality of key performance indicators is normalized for the documentation applications installed on the portable communication device according to the wired network with the finite bandwidth. In yet another embodiment of the present disclosure, the plurality of key performance indicators is normalized for the documentation applications installed on the portable communication device according to the optical fiber high bandwidth network.

In an embodiment of the present disclosure, the plurality of key performance indicators is normalized for the documentation applications installed on the fixed communication device according to the quality of the internet connection. In another embodiment of the present disclosure, the plurality of key performance indicators is normalized for the documentation applications installed on the fixed communication device according to the quality of the wireless mobile network. In yet another embodiment of the present disclosure, the plurality of key performance indicators is normalized for the documentation applications installed on the fixed communication device according to the quality of the wired network with the finite bandwidth. In yet another embodiment of the present disclosure, the plurality of key performance indicators is normalized for the documentation applications installed on the fixed communication device according to the quality of the optical fiber high bandwidth network.

In an embodiment of the present disclosure, the plurality of key performance indicators is normalized for the data management applications installed on the portable communication device according to the quality of the internet connection. In another embodiment of the present disclosure, the plurality of key performance indicators is normalized for the data management applications installed on the portable communication device according to the wireless mobile network. In yet another embodiment of the present disclosure, the plurality of key performance indicators is normalized for the data management applications installed on the portable communication device according to the wired network with the finite bandwidth. In yet another embodiment of the present disclosure, the plurality of key performance indicators is normalized for the data management applications installed on the portable communication device according to the optical fiber high bandwidth network.

In an embodiment of the present disclosure, the plurality of key performance indicators is normalized for the data management applications installed on the fixed communication device according to the quality of the internet connection. In another embodiment of the present disclosure, the plurality of key performance indicators is normalized for the data management applications installed on the fixed communication device according to the quality of the wireless mobile network. In yet another embodiment of the present disclosure, the plurality of key performance indicators is normalized for the data management applications installed on the fixed communication device according to the quality of the wired network with the finite bandwidth. In yet another embodiment of the present disclosure, the plurality of key performance indicators is normalized for the data management applications installed on the fixed communication device according to the quality of the optical fiber high bandwidth network.

In an embodiment of the present disclosure, the plurality of key performance indicators is normalized for the financial applications installed on the portable communication device according to the quality of the internet connection. In another embodiment of the present disclosure, the plurality of key performance indicators is normalized for the financial applications installed on the portable communication device according to the wireless mobile network. In yet another embodiment of the present disclosure, the plurality of key performance indicators is normalized for the financial applications installed on the portable communication device according to the wired network with the finite bandwidth. In yet another embodiment of the present disclosure, the plurality of key performance indicators is normalized for the financial applications installed on the portable communication device according to the optical fiber high bandwidth network.

In an embodiment of the present disclosure, the plurality of key performance indicators is normalized for the financial applications installed on the fixed communication device according to the quality of the internet connection. In another embodiment of the present disclosure, the plurality of key performance indicators is normalized for the financial applications installed on the fixed communication device according to the quality of the wireless mobile network. In yet another embodiment of the present disclosure, the plurality of key performance indicators is normalized for the financial applications installed on the fixed communication device according to the quality of the wired network with the finite bandwidth. In yet another embodiment of the present disclosure, the plurality of key performance indicators is normalized for the financial applications installed on the fixed communication device according to the quality of the optical fiber high bandwidth network.

In an embodiment of the present disclosure, the plurality of key performance indicators is normalized for the entertainment applications installed on the portable communication device according to the quality of the internet connection. In another embodiment of the present disclosure, the plurality of key performance indicators is normalized for the entertainment applications installed on the portable communication device according to the wireless mobile network. In yet another embodiment of the present disclosure, the plurality of key performance indicators is normalized for the entertainment applications installed on the portable communication device according to the wired network with the finite bandwidth. In yet another embodiment of the present disclosure, the plurality of key performance indicators is normalized for the entertainment applications installed on the portable communication device according to the optical fiber high bandwidth network.

In an embodiment of the present disclosure, the plurality of key performance indicators is normalized for the entertainment applications installed on the fixed communication device according to the quality of the internet connection. In another embodiment of the present disclosure, the plurality of key performance indicators is normalized for the entertainment applications installed on the fixed communication device according to the quality of the wireless mobile network. In yet another embodiment of the present disclosure, the plurality of key performance indicators is normalized for the entertainment applications installed on the fixed communication device according to the quality of the wired network with the finite bandwidth. In yet another embodiment of the present disclosure, the plurality of key performance indicators is normalized for the entertainment applications installed on the fixed communication device according to the quality of the optical fiber high bandwidth network.

In an embodiment of the present disclosure, the plurality of key performance indicators is normalized for the educational applications installed on the portable communication device according to the quality of the internet connection. In another embodiment of the present disclosure, the plurality of key performance indicators is normalized for the educational applications installed on the portable communication device according to the wireless mobile network. In yet another embodiment of the present disclosure, the plurality of key performance indicators is normalized for the educational applications installed on the portable communication device according to the wired network with the finite bandwidth. In yet another embodiment of the present disclosure, the plurality of key performance indicators is normalized for the educational applications installed on the portable communication device according to the optical fiber high bandwidth network.

In an embodiment of the present disclosure, the plurality of key performance indicators is normalized for the educational applications installed on the fixed communication device according to the quality of the internet connection. In another embodiment of the present disclosure, the plurality of key performance indicators is normalized for the educational applications installed on the fixed communication device according to the quality of the wireless mobile network. In yet another embodiment of the present disclosure, the plurality of key performance indicators is normalized for the educational applications installed on the fixed communication device according to the quality of the wired network with the finite bandwidth. In yet another embodiment of the present disclosure, the plurality of key performance indicators is normalized for the educational applications installed on the fixed communication device according to the quality of the optical fiber high bandwidth network.

In an embodiment of the present disclosure, the plurality of key performance indicators is normalized for the enterprise applications installed on the portable communication device according to the quality of the internet connection. In another embodiment of the present disclosure, the plurality of key performance indicators is normalized for the enterprise applications installed on the portable communication device according to the wireless mobile network. In yet another embodiment of the present disclosure, the plurality of key performance indicators is normalized for the enterprise applications installed on the portable communication device according to the wired network with the finite bandwidth. In yet another embodiment of the present disclosure, the plurality of key performance indicators is normalized for the enterprise applications installed on the portable communication device according to the optical fiber high bandwidth network.

In an embodiment of the present disclosure, the plurality of key performance indicators is normalized for the enterprise applications installed on the fixed communication device according to the quality of the internet connection. In another embodiment of the present disclosure, the plurality of key performance indicators is normalized for the enterprise applications installed on the fixed communication device according to the quality of the wireless mobile network. In yet another embodiment of the present disclosure, the plurality of key performance indicators is normalized for the enterprise applications installed on the fixed communication device according to the quality of the wired network with the finite bandwidth. In yet another embodiment of the present disclosure, the plurality of key performance indicators is normalized for the enterprise applications installed on the fixed communication device according to the quality of the optical fiber high bandwidth network.

The quality quantification system 110 evaluates the application quality index based on the analysis performed by the machine learning model using the one or more machine learning algorithms. In addition, the quality quantification system 110 predicts the application experience based on the quality of the communication network 108 of corresponding user of the plurality of users 102. Furthermore, the prediction of the application experience enables each of the plurality of developers to initiate the suitable actions to enhance the application experience. Moreover, the quality quantification system 110 predicts the user action based on the application experience to enable each of the plurality of developers of the one or more applications 106 to initiate the suitable actions to enhance the application experience.

The quality quantification system 110 enables the plurality of developers to analyze the application experience of the plurality of users 102 on the one or more applications 106. In addition, the application experience depends on a plurality of factors. Further, the plurality of factors includes signal strength, quality, transmission power, handover latency, Inter Radio Access Technologies, downlink throughput, uplink throughput, and latency. Furthermore, the plurality of factors include but may not be limited to packet loss, jitter, web latency of websites, and video latency from user end.

The quality quantification system 110 recommends the suitable actions to the plurality of developers of the one or more applications 106 to enhance the application experience. In addition, the quality quantification system 110 predicts the user action based on the application experience to prevent loss of the revenue and the plurality of users 102 using the one or more machine learning algorithms.

In an embodiment of the present disclosure, the quality quantification system 110 predicts the application experience of the documentation applications installed on the portable communication device based on the quality of the internet connection. In another embodiment of the present disclosure, the quality quantification system 110 predicts the application experience of the documentation applications installed on the portable communication device based on the quality of the wireless mobile network. In yet another embodiment of the present disclosure, the quality quantification system 110 predicts the application experience of the documentation applications installed on the portable communication device based on the quality of the wired network with the finite bandwidth. In yet another embodiment of the present disclosure, the quality quantification system 110 predicts the application experience of the documentation applications installed on the portable communication device based on the quality of the optical fiber high bandwidth network.

In an embodiment of the present disclosure, the quality quantification system 110 predicts the application experience of the documentation applications installed on the fixed communication device based on the quality of the internet connection. In another embodiment of the present disclosure, the quality quantification system 110 predicts the application experience of the documentation applications installed on the fixed communication device based on the quality of the wireless mobile network. In yet another embodiment of the present disclosure, the quality quantification system 110 predicts the application experience of the documentation applications installed on the fixed communication device based on the quality of the wired network with the finite bandwidth. In yet another embodiment of the present disclosure, the quality quantification system 110 predicts the application experience of the documentation applications installed on the fixed communication device based on the quality of the optical fiber high bandwidth network.

In an embodiment of the present disclosure, the quality quantification system 110 predicts the application experience of the data management applications installed on the portable communication device based on the quality of the internet connection. In another embodiment of the present disclosure, the quality quantification system 110 predicts the application experience of the data management applications installed on the portable communication device based on the quality of the wireless mobile network. In yet another embodiment of the present disclosure, the quality quantification system 110 predicts the application experience of the data management applications installed on the portable communication device based on the quality of the wired network with the finite bandwidth. In yet another embodiment of the present disclosure, the quality quantification system 110 predicts the application experience of the data management applications installed on the portable communication device based on the quality of the optical fiber high bandwidth network.

In an embodiment of the present disclosure, the quality quantification system 110 predicts the application experience of the data management applications installed on the fixed communication device based on the quality of the internet connection. In another embodiment of the present disclosure, the quality quantification system 110 predicts the application experience of the data management applications installed on the fixed communication device based on the quality of the wireless mobile network. In yet another embodiment of the present disclosure, the quality quantification system 110 predicts the application experience of the data management applications installed on the fixed communication device based on the quality of the wired network with the finite bandwidth. In yet another embodiment of the present disclosure, the quality quantification system 110 predicts the application experience of the data management applications installed on the fixed communication device based on the quality of the optical fiber high bandwidth network.

In an embodiment of the present disclosure, the quality quantification system 110 predicts the application experience of the financial applications installed on the portable communication device based on the quality of the internet connection. In another embodiment of the present disclosure, the quality quantification system 110 predicts the application experience of the financial applications installed on the portable communication device based on the quality of the wireless mobile network. In yet another embodiment of the present disclosure, the quality quantification system 110 predicts the application experience of the financial applications installed on the portable communication device based on the quality of the wired network with the finite bandwidth. In yet another embodiment of the present disclosure, the quality quantification system 110 predicts the application experience of the financial applications installed on the portable communication device based on the quality of the optical fiber high bandwidth network.

In an embodiment of the present disclosure, the quality quantification system 110 predicts the application experience of the financial applications installed on the fixed communication device based on the quality of the internet connection. In another embodiment of the present disclosure, the quality quantification system 110 predicts the application experience of the financial applications installed on the fixed communication device based on the quality of the wireless mobile network. In yet another embodiment of the present disclosure, the quality quantification system 110 predicts the application experience of the financial applications installed on the fixed communication device based on the quality of the wired network with the finite bandwidth. In yet another embodiment of the present disclosure, the quality quantification system 110 predicts the application experience of the financial applications installed on the fixed communication device based on the quality of the optical fiber high bandwidth network.

In an embodiment of the present disclosure, the quality quantification system 110 predicts the application experience of the entertainment applications installed on the portable communication device based on the quality of the internet connection. In another embodiment of the present disclosure, the quality quantification system 110 predicts the application experience of the entertainment applications installed on the portable communication device based on the quality of the wireless mobile network. In yet another embodiment of the present disclosure, the quality quantification system 110 predicts the application experience of the entertainment applications installed on the portable communication device based on the quality of the wired network with the finite bandwidth. In yet another embodiment of the present disclosure, the quality quantification system 110 predicts the application experience of the entertainment applications installed on the portable communication device based on the quality of the optical fiber high bandwidth network.

In an embodiment of the present disclosure, the quality quantification system 110 predicts the application experience of the entertainment applications installed on the fixed communication device based on the quality of the internet connection. In another embodiment of the present disclosure, the quality quantification system 110 predicts the application experience of the entertainment applications installed on the fixed communication device based on the quality of the wireless mobile network. In yet another embodiment of the present disclosure, the quality quantification system 110 predicts the application experience of the entertainment applications installed on the fixed communication device based on the quality of the wired network with the finite bandwidth. In yet another embodiment of the present disclosure, the quality quantification system 110 predicts the application experience of the entertainment applications installed on the fixed communication device based on the quality of the optical fiber high bandwidth network.

In an embodiment of the present disclosure, the quality quantification system 110 predicts the application experience of the educational applications installed on the portable communication device based on the quality of the internet connection. In another embodiment of the present disclosure, the quality quantification system 110 predicts the application experience of the educational applications installed on the portable communication device based on the quality of the wireless mobile network. In yet another embodiment of the present disclosure, the quality quantification system 110 predicts the application experience of the educational applications installed on the portable communication device based on the quality of the wired network with the finite bandwidth. In yet another embodiment of the present disclosure, the quality quantification system 110 predicts the application experience of the educational applications installed on the portable communication device based on the quality of the optical fiber high bandwidth network.

In an embodiment of the present disclosure, the quality quantification system 110 predicts the application experience of the educational applications installed on the fixed communication device based on the quality of the internet connection. In another embodiment of the present disclosure, the quality quantification system 110 predicts the application experience of the educational applications installed on the fixed communication device based on the quality of the wireless mobile network. In yet another embodiment of the present disclosure, the quality quantification system 110 predicts the application experience of the educational applications installed on the fixed communication device based on the quality of the wired network with the finite bandwidth. In yet another embodiment of the present disclosure, the quality quantification system 110 predicts the application experience of the educational applications installed on the fixed communication device based on the quality of the optical fiber high bandwidth network.

In an embodiment of the present disclosure, the quality quantification system 110 recommends the suitable actions for the documentation applications installed on the portable communication device based on the quality of the internet connection. In another embodiment of the present disclosure, the quality quantification system 110 recommends the suitable actions for the documentation applications installed on the portable communication device based on the quality of the wireless mobile network. In yet another embodiment of the present disclosure, the quality quantification system 110 recommends the suitable actions for the documentation applications installed on the portable communication device based on the quality of the wired network with the finite bandwidth. In yet another embodiment of the present disclosure, the quality quantification system 110 recommends the suitable actions for the documentation applications installed on the portable communication device based on the quality of the optical fiber high bandwidth network.

In an embodiment of the present disclosure, the quality quantification system 110 recommends the suitable actions for the documentation applications installed on the fixed communication device based on the quality of the internet connection. In another embodiment of the present disclosure, the quality quantification system 110 recommends the suitable actions for the documentation applications installed on the fixed communication device based on the quality of the wireless mobile network. In yet another embodiment of the present disclosure, the quality quantification system 110 recommends the suitable actions for the documentation applications installed on the fixed communication device based on the quality of the wired network with the finite bandwidth.

In yet another embodiment of the present disclosure, the quality quantification system 110 recommends the suitable actions for the documentation applications installed on the fixed communication device based on the quality of the optical fiber high bandwidth network.

In an embodiment of the present disclosure, the quality quantification system 110 recommends the suitable actions for the data management applications installed on the portable communication device based on the quality of the internet connection. In another embodiment of the present disclosure, the quality quantification system 110 recommends the suitable actions for the data management applications installed on the portable communication device based on the quality of the wireless mobile network. In yet another embodiment of the present disclosure, the quality quantification system 110 recommends the suitable actions for the data management applications installed on the portable communication device based on the quality of the wired network with the finite bandwidth.

In yet another embodiment of the present disclosure, the quality quantification system 110 recommends the suitable actions for the data management applications installed on the portable communication device based on the quality of the optical fiber high bandwidth network.

In an embodiment of the present disclosure, the quality quantification system 110 recommends the suitable actions for the data management applications installed on the fixed communication device based on the quality of the internet connection. In another embodiment of the present disclosure, the quality quantification system 110 recommends the suitable actions for the data management applications installed on the fixed communication device based on the quality of the wireless mobile network. In yet another embodiment of the present disclosure, the quality quantification system 110 recommends the suitable actions for the data management applications installed on the fixed communication device based on the quality of the wired network with the finite bandwidth. In yet another embodiment of the present disclosure, the quality quantification system 110 recommends the suitable actions for the data management applications installed on the fixed communication device based on the quality of the optical fiber high bandwidth network.

In an embodiment of the present disclosure, the quality quantification system 110 recommends the suitable actions for the financial applications installed on the portable communication device based on the quality of the internet connection. In another embodiment of the present disclosure, the quality quantification system 110 recommends the suitable actions for the financial applications installed on the portable communication device based on the quality of the wireless mobile network. In yet another embodiment of the present disclosure, the quality quantification system 110 recommends the suitable actions for the financial applications installed on the portable communication device based on the quality of the wired network with the finite bandwidth. In yet another embodiment of the present disclosure, the quality quantification system 110 recommends the suitable actions for the financial applications installed on the portable communication device based on the quality of the optical fiber high bandwidth network.

In an embodiment of the present disclosure, the quality quantification system 110 recommends the suitable actions for the financial applications installed on the fixed communication device based on the quality of the internet connection. In another embodiment of the present disclosure, the quality quantification system 110 recommends the suitable actions for the financial applications installed on the fixed communication device based on the quality of the wireless mobile network. In yet another embodiment of the present disclosure, the quality quantification system 110 recommends the suitable actions for the financial applications installed on the fixed communication device based on the quality of the wired network with the finite bandwidth. In yet another embodiment of the present disclosure, the quality quantification system 110 recommends the suitable actions for the financial applications installed on the fixed communication device based on the quality of the optical fiber high bandwidth network.

In an embodiment of the present disclosure, the quality quantification system 110 recommends the suitable actions for the entertainment applications installed on the portable communication device based on the quality of the internet connection. In another embodiment of the present disclosure, the quality quantification system 110 recommends the suitable actions for the entertainment applications installed on the portable communication device based on the quality of the wireless mobile network. In yet another embodiment of the present disclosure, the quality quantification system 110 recommends the suitable actions for the entertainment applications installed on the portable communication device based on the quality of the wired network with the finite bandwidth. In yet another embodiment of the present disclosure, the quality quantification system 110 recommends the suitable actions for the entertainment applications installed on the portable communication device based on the quality of the optical fiber high bandwidth network.

In an embodiment of the present disclosure, the quality quantification system 110 recommends the suitable actions for the entertainment applications installed on the fixed communication device based on the quality of the internet connection. In another embodiment of the present disclosure, the quality quantification system 110 recommends the suitable actions for the entertainment applications installed on the fixed communication device based on the quality of the wireless mobile network. In yet another embodiment of the present disclosure, the quality quantification system 110 recommends the suitable actions for the entertainment applications installed on the fixed communication device based on the quality of the wired network with the finite bandwidth. In yet another embodiment of the present disclosure, the quality quantification system 110 recommends the suitable actions for the entertainment applications installed on the fixed communication device based on the quality of the optical fiber high bandwidth network.

In an embodiment of the present disclosure, the quality quantification system 110 recommends the suitable actions for the educational applications installed on the portable communication device based on the quality of the internet connection. In another embodiment of the present disclosure, the quality quantification system 110 recommends the suitable actions for the educational applications installed on the portable communication device based on the quality of the wireless mobile network. In yet another embodiment of the present disclosure, the quality quantification system 110 recommends the suitable actions for the educational applications installed on the portable communication device based on the quality of the wired network with the finite bandwidth. In yet another embodiment of the present disclosure, the quality quantification system 110 recommends the suitable actions for the educational applications installed on the portable communication device based on the quality of the optical fiber high bandwidth network.

In an embodiment of the present disclosure, the quality quantification system 110 recommends the suitable actions for the educational applications installed on the fixed communication device based on the quality of the internet connection. In another embodiment of the present disclosure, the quality quantification system 110 recommends the suitable actions for the educational applications installed on the fixed communication device based on the quality of the wireless mobile network. In yet another embodiment of the present disclosure, the quality quantification system 110 recommends the suitable actions for the educational applications installed on the fixed communication device based on the quality of the wired network with the finite bandwidth. In yet another embodiment of the present disclosure, the quality quantification system 110 recommends the suitable actions for the educational applications installed on the fixed communication device based on the quality of the optical fiber high bandwidth network.

In an example, a user U1 accesses an application A1 (Let's say a documentation application) on a communication device D1 (Let's say a desktop) using a communication network N1 (Let's say internet connection) in a geolocation G1. In addition, the user U1 provides a user feedback F1 after accessing the application A1 through the communication device D1 using the communication network N1. Further, the quality quantification system 110 receives data associated with the documentation application, the desktop, the internet connection, and the geolocation G1. Furthermore, the quality quantification system 110 collects the user feedback F1 for the application A1 for the communication device D1 for the communication network N1. Moreover, the quality quantification system 110 evaluates the application quality index for the documentation application accessed on the desktop using the internet connection in the geolocation G1. Also, the quality quantification system 110 predicts the application experience for the documentation application accessed on the desktop using the internet connection in the geolocation G1.

In another example, a user U2 accesses an application A2 (Let's say a data management application) on a communication device D2 (Let's say a tablet) using a communication network N2 (Let's say a wireless mobile network) in a geolocation G2. In addition, the user U2 provides a user feedback F2 after accessing the application A2 through the communication device D2 using the communication network N2. Further, the quality quantification system 110 receives data associated with the data management application, the tablet, the wireless mobile network, and the geolocation G2. Furthermore, the quality quantification system 110 collects the user feedback F2 for the application A2 for the communication device D2 for the communication network N2. Moreover, the quality quantification system 110 evaluates the application quality index for the data management application accessed on the tablet using the wireless mobile network in the geolocation G2. Also, the quality quantification system 110 predicts the application experience for the data management application accessed on the tablet using the wireless mobile network in the geolocation G2.

In yet another example, a user U3 accesses an application A3 (Let's say a financial application) on a communication device D3 (Let's say a laptop) using a communication network N3 (Let's say a wired network with the finite bandwidth) in a geolocation G3. In addition, the user U3 provides a user feedback F3 after accessing the application A3 through the communication device D3 using the communication network N3. Further, the quality quantification system 110 receives data associated with the financial application, the laptop, the wired network with the finite bandwidth, and the geolocation G3. Furthermore, the quality quantification system 110 collects the user feedback F3 for the application A3 for the communication device D3 for the communication network N3. Moreover, the quality quantification system 110 evaluates the application quality index for the financial application accessed on the laptop using the wired network with the finite bandwidth in the geolocation G3. Also, the quality quantification system 110 predicts the application experience for the financial application accessed on the laptop using the wired network with the finite bandwidth in the geolocation G3.

In yet another example, a user U4 accesses an application A4 (Let's say an entertainment application) on a communication device D4 (Let's say a smartphone) using a communication network N4 (Let's say an optical fiber high bandwidth network) in a geolocation G4. In addition, the user U4 provides a user feedback F4 after accessing the application A4 through the communication device D4 using the communication network N4. Further, the quality quantification system 110 receives data associated with the entertainment application, the smartphone, the optical fiber high bandwidth network, and the geolocation G4. Furthermore, the quality quantification system 110 collects the user feedback F4 for the application A4 for the communication device D4 for the communication network N4. Moreover, the quality quantification system 110 evaluates the application quality index for the entertainment application accessed on the smartphone using the optical fiber high bandwidth network in the geolocation G4. Also, the quality quantification system 110 predicts the application experience for the entertainment application accessed on the smartphone using the optical fiber high bandwidth network in the geolocation G4.

The functional architecture 200 includes the quality quantification system 110 and the one or more data sources 208. In addition, the quality quantification system 110 includes a data management module 202, an analytics module 204, and a presentation module 206. Further, the data management module 202 includes data collection, data enrichment, data aggregation, and data storage. Furthermore, the analytics module 204 includes an application quality index (AQI) calculator, an application customer perception and performance correlator, and a network and application performance correlator. Moreover, the presentation module 206 includes map view, statistical view, and application program interface (API). Also, the one or more data sources 208 include application active test system, real user monitoring system, and network and cloud active testing systems. Also, the one or more data sources 208 include customer surveys and other business systems, and datacenter, cloud or CDN logs.

The application active test system is an external system that conducts active application test on the one or more applications 106. In addition, the application active test system provides real user experience and application load time from the plurality of key performance indicators. Further, the application active test system conducts the active application test on each of the one or more applications 106 present in multiple geo-location points under real quality and condition of the communication network 108. Furthermore, the application active test system conducts the active application test on the one or more communication devices 104. Moreover, the application active test system collects network logs, device logs, operating system (OS) logs, and automation logs to measure the application experience for each of the plurality of users 102.

The real user monitoring system passively collects the user journey data and the user experience data from each of the one or more applications 106 through a software development kit integrated into the one or more applications 106. In addition, the plurality of developers instruments the user journey data and the user experience data to collect the plurality of key performance indicators from each of the one or more communication devices 104.

The network and cloud active testing systems correspond to module that conduct active testing and crowdsourcing. In addition, the network and cloud active testing systems are installed in the multiple geo-location points within a geography or the software development kit that is integrated into the one or more applications 106. Further, the network and cloud active testing systems fetch data associated with the plurality of factors from the multiple geo-location points of the plurality of users 102. Furthermore, the plurality of factors includes the signal strength, the quality, the transmission power, the handover latency, the Inter Radio Access Technologies, the downlink throughput, and the uplink throughput. Moreover, the plurality of factors includes the jitter, the packet loss, the web latency of websites, the latency, the video latency from user end, and the like.

The customer surveys and other business systems correspond to module that conduct survey based metrics that reflects perception of each of the plurality of users 102 of the application experience. In addition, the survey based metrics include but may not be limited to net promoter score (NPS), customer churn, drop in engagement, subscription upgrades, and subscription downgrades.

The datacenter, cloud or CDN logs correspond to module that provides data collected from the logs generated by the datacenter, cloud service providers, and content delivery networks. In an embodiment of the present disclosure, the cloud service providers are public service providers. In another embodiment of the present disclosure, the cloud service providers are private service providers.

The data collection corresponds to module that collects the technical application data, the application business data, the user journey data and the user experience data from the one or more data sources 208. In addition, the data management module 202 integrates with an interface of the quality quantification system 110 to collect the data to calculate the application quality index.

The data enrichment corresponds to module that cleans and enriches the technical application data, the application business data, the user journey data and the user experience data using processed information. In addition, the processed information includes geo-location bin identity.

The data aggregation corresponds to module that organizes the technical application data, the application business data, the user journey data and the user experience data through the plurality of users 102 and the geo-location bin identity. In addition, the data management module 202 may organize the technical application data, the application business data, the user journey data and the user experience data based on aggregation logic using the data aggregation. Further, the aggregation logic includes but may not be limited to model of the one or more communication devices 104, city, and country.

The data storage corresponds to module that stores the technical application data, the application business data, the user journey data and the user experience data. In an embodiment of the present disclosure, the data storage is a long-term data storage. In addition, the long-term data storage is utilized for analytics, developing and training the machine learning model. In another embodiment of the present disclosure, the data storage is a hot data storage. The hot data storage is utilized for presentation and real time querying.

The application quality index (AQI) calculator aggregates the technical application data, the application business data, the user journey data and the user experience data that are enriched at user level and geography level. In addition, the application quality index (AQI) calculator aggregates the technical application data, the application business data, the user journey data and the user experience data based on the one or more aspects of the user experience. Further, the one or more aspects include but may not be limited to the application responsiveness, the video streaming experience, the video quality, the audio quality, and the transaction performance. Furthermore, the application quality index (AQI) calculator provides the application quality index that is constituted by the plurality of key performance indicators. Moreover, each of the plurality of key performance indicators is dynamic and depends on category of the one or more applications 106 and data availability.

The network and application performance correlator predicts the application experience based on the quality and performance of the communication network 108 of corresponding user of the plurality of users 102. In addition, the prediction of the application experience enables each of the plurality of developers to initiate the suitable actions to enhance the application experience. Further, the network and application performance correlator enables correlation of the quality of the communication network 108 to actual application experience. Furthermore, the correlation is performed for each of the plurality of key performance indicators to enable each of the plurality of developers to analyze the user journey and the user experience of the plurality of users 102. The application customer perception and performance correlator predicts the user action based on the application experience to prevent loss of the revenue and the plurality of users 102 using the one or more machine learning algorithms. In addition, application customer perception and performance correlator enables the correlation of the application quality index with the customer surveys and other business systems.

The statistical view enables the administrator 116 to perform various statistical analysis. The various statistical analyses include but may not be limited to understanding aggregate application quality index, device segment, and geography. In addition, the map view enables the administrator 116 to search the application quality index across the multiple geo-location points within the geography based on actual and predicted data. Further, the application quality index is visible through the application program interface (API) integrated into various other systems for a plurality of actions. Furthermore, the plurality of actions include but may not be limited to marketing automation platforms, content distribution network switching engines, and access network switching.

The interactive computing environment 100 includes the server 112 and the database 114. The quality quantification system 110 is associated with the server 112. In general, server is a computer program or device that provides functionality for other programs or devices. The server 112 provides various functionalities, such as sharing data or resources among multiple clients, or performing computation for a client. However, those skilled in the art would appreciate that the quality quantification system 110 is connected to more number of servers. Furthermore, it may be noted that the server 112 includes the database 114. However, those skilled in the art would appreciate that more number of the servers include more numbers of database.

In an embodiment of the present disclosure, the quality quantification system 110 is located in the server 112. In another embodiment of the present disclosure, the quality quantification system 110 is connected with the server 112. In yet another embodiment of the present disclosure, the quality quantification system 110 is a part of the server 112. The server 112 handles each operation and task performed by the quality quantification system 110. The server 112 stores one or more instructions for performing the various operations of the quality quantification system 110. The server 112 is located remotely from the quality quantification system 110. The server 112 is associated with the administrator 116. In general, administrator manages the different components in system. The administrator 116 coordinates the activities of the components involved in the quality quantification system 110. The administrator 116 is any person or individual who monitors the working of the quality quantification system 110 and the server 112 in real-time. The administrator 116 monitors the working of the quality quantification system 110 and the server 112 through a communication device. The communication device includes the laptop, the desktop computer, the tablet, a personal digital assistant and the like.

The database 114 stores different sets of information associated with various components of the quality quantification system 110. In general, the database is used to hold general information and specialized data, such as the user journey data and the user experience data of the plurality of users 102, the technical application data of the one or more applications 106, the application business data of the one or more applications 106 and the like. The database 114 stores the information of the one or more applications 106, the one or more communication devices 104, the plurality of users 102, and the like. The database 114 organizes the data using model such as relational models or hierarchical models. Further, the database 114 store data provided by the administrator 116.

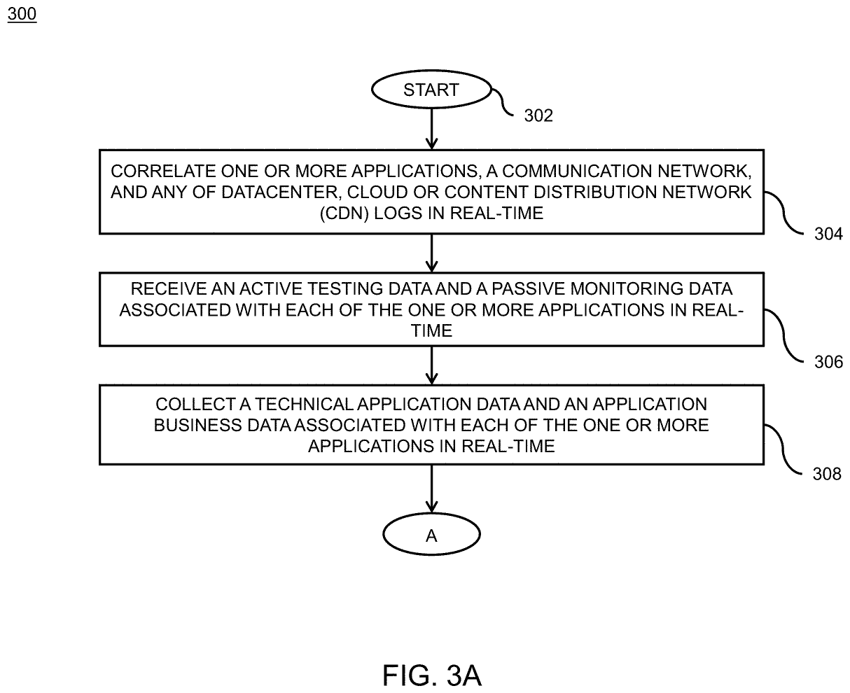

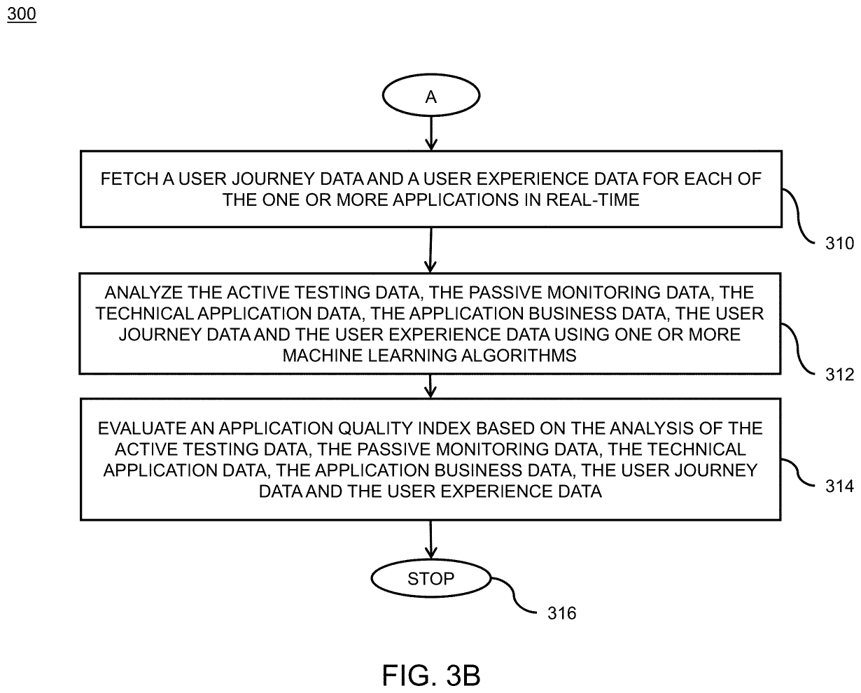

FIGS. 3A and 3B illustrate a flowchart 300 for measuring the application experience in real time, in accordance with various embodiments of the present disclosure. It may be noted that in order to explain the method steps of the flowchart 300, references will be made to the elements explained in FIG. 1. The flowchart 300 starts at step 302. At step 304, the quality quantification system 110 correlates the one or more applications 106, the communication network 108, and any of the datacenter, the cloud or the content distribution network (CDN) logs in real-time. At step 306, the quality quantification system 110 receives the active testing data and the passive monitoring data associated with each of the one or more applications 106 in real-time. At step 308, the quality quantification system 110 collects the technical application data and the application business data associated with each of the one or more applications 106 in real-time. At step 310, the quality quantification system 110 fetches the user journey data and the user experience data for each of the one or more applications 106 in real-time. At step 312, the quality quantification system 110 analyzes the active testing data, the passive monitoring data, the technical application data, the application business data, the user journey data and the user experience data. At step 314, the quality quantification system 110 evaluates the application quality index based on the analysis.

The flowchart 300 terminates at step 316. It may be noted that the flowchart 300 is explained to have above stated process steps; however, those skilled in the art would appreciate that the flowchart 300 may have more/less number of process steps which may enable all the above stated embodiments of the present disclosure.

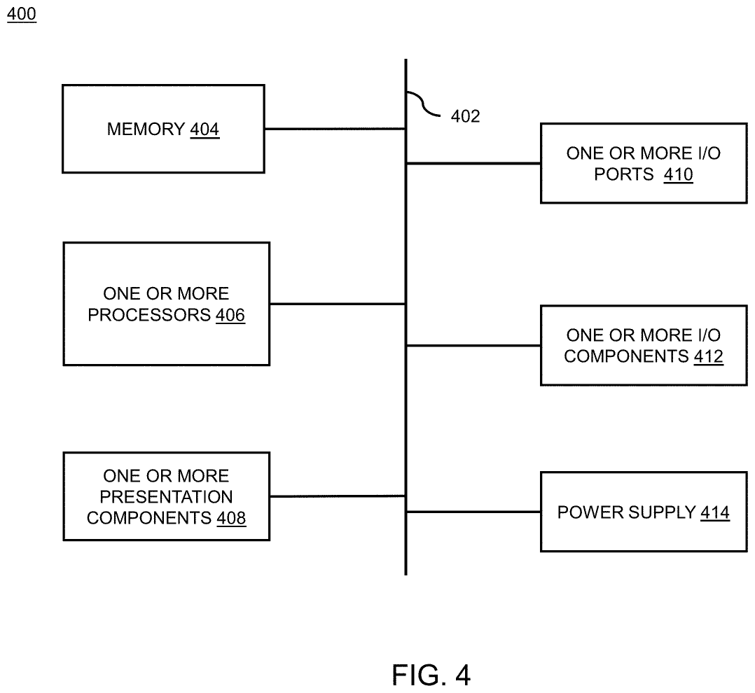

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. The distinction is not made between such categories as “workstation,” “server,” “laptop,” “hand-held device,” etc., as all are contemplated within the scope of FIG. 4 and reference to “computing device.” The computing device 400 typically includes a variety of computer-readable media.

The computer-readable media can be any available media that can be accessed by the computing device 400 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 404 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The computer-readable storage media associated with the memory 404 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The computing device 400 includes one or more processors that read data from various entities such as the memory 404 or I/O components 412. The one or more presentation components 308 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to explain the principles of the present technology best and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for measuring application experience, the computer-implemented method comprising:
correlating, at a quality quantification system with a processor, one or more applications, a communication network, and any of datacenter, cloud or content distribution network (CDN) logs in real-time;
receiving, at the quality quantification system with the processor, an active testing data and a passive monitoring data associated with each of the one or more applications in real-time;
collecting, at the quality quantification system with the processor, a technical application data and an application business data associated with each of the one or more applications in real-time;
fetching, at the quality quantification system with the processor, a user journey data and a user experience data for each of the one or more applications in real-time;
analyzing, at the quality quantification system with the processor, the active testing data, the passive monitoring data, the technical application data, the application business data, the user journey data and the user experience data using one or more machine learning algorithms, wherein the analysis is performed based on training of a machine learning model, wherein the analysis is performed in real time; and
evaluating, at the quality quantification system with the processor, an application quality index based on the analysis of the active testing data, the passive monitoring data, the technical application data, the application business data, the user journey data and the user experience data.

2. The computer-implemented method as recited in claim 1, further comprising integrating, at the quality quantification system with the processor, the active testing data and the passive monitoring data associated with each of the one or more applications for enabling the evaluation of the application quality index.

3. The computer-implemented method as recited in claim 1, wherein the technical application data corresponds to data associated with performance of each of the one or more applications, wherein the application business data comprising application churn rate and drop in engagement, wherein the technical application data and the application business data are a plurality of key performance indicators for evaluating the application quality index of each of the one or more applications, wherein the technical application data is dependent on one or more features, wherein the one or more features comprising load speed, one or more communication devices, operating system, and crash reports, wherein the application business data depends on a plurality of aspects, wherein the plurality of aspects comprising session length, average application visits, daily active users, retention rate, and revenue.

4. The computer-implemented method as recited in claim 1, further comprising normalizing, at the quality quantification system with the processor, the plurality of key performance indicators for evaluating the application quality index for each of the one or more applications, wherein the plurality of key performance indicators is normalized in accordance to quality of the communication network of corresponding user of a plurality of users.

5. The computer-implemented method as recited in claim 1, further comprising predicting, at the quality quantification system with the processor, the application experience based on the quality of the communication network of corresponding user of the plurality of users, wherein the application experience enables each of a plurality of developers of the one or more applications for initiating suitable actions for enhancing the application experience.

6. The computer-implemented method as recited in claim 1, further comprising predicting, at the quality quantification system with the processor, user action based on the application experience for enabling each of the plurality of developers of the one or more applications for initiating the suitable actions for enhancing the application experience.

7. The computer-implemented method as recited in claim 1, further comprising enabling, at the quality quantification system with the processor, the plurality of developers to analyze the application experience of the plurality of users on the one or more applications, wherein the application experience depends on a plurality of factors, wherein the plurality of factors comprising signal strength, quality, transmission power, handover latency, Inter Radio Access Technologies, downlink throughput, uplink throughput, latency, packet loss, jitter, web latency of websites, and video latency from user end.

8. The computer-implemented method as recited in claim 1, further comprising recommending, at the quality quantification system with the processor, the suitable actions to the plurality of developers of the one or more applications for enhancing the application experience.

9. The computer-implemented method as recited in claim 1, further comprising aggregating, at the quality quantification system with the processor, the technical application data, the application business data, the user journey data and the user experience data based on one or more aspects, wherein the one or more aspects comprising application responsiveness, video streaming experience, video quality, audio quality, and transaction performance.

10. A computer system comprising:
one or more processors; and
a memory coupled to the one or more processors, the memory for storing instructions which, when executed by the one or more processors, cause the one or more processors to perform a method for measuring application experience, the method comprising:
correlating, at a quality quantification system, one or more applications, a communication network, and any of datacenter, cloud or content distribution network (CDN) logs in real-time;
receiving, at the quality quantification system, an active testing data and a passive monitoring data associated with each of the one or more applications in real-time;
collecting, at the quality quantification system, a technical application data and an application business data associated with each of the one or more applications in real-time;
fetching, at the quality quantification system, a user journey data and a user experience data for each of the one or more applications in real-time;
analyzing, at the quality quantification system, the active testing data, the passive monitoring data, the technical application data, the application business data, the user journey data and the user experience data using one or more machine learning algorithms, wherein the analysis is performed based on training of a machine learning model, wherein the analysis is performed in real time; and
evaluating, at the quality quantification system, an application quality index based on the analysis of the active testing data, the passive monitoring data, the technical application data, the application business data, the user journey data and the user experience data.

11. The computer system as recited in claim 10, further comprising integrating, at the quality quantification system, the active testing data and the passive monitoring data associated with each of the one or more applications for enabling the evaluation of the application quality index.

12. The computer system as recited in claim 10, wherein the technical application data corresponds to data associated with performance of each of the one or more applications, wherein the application business data comprising application churn rate and drop in engagement, wherein the technical application data and the application business data are a plurality of key performance indicators for evaluating the application quality index of each of the one or more applications, wherein the technical application data is dependent on one or more features, wherein the one or more features comprising load speed, one or more communication devices, operating system, and crash reports, wherein the application business data depends on a plurality of aspects, wherein the plurality of aspects comprising session length, average application visits, daily active users, retention rate, and revenue.

13. The computer system as recited in claim 10, further comprising normalizing, at the quality quantification system, the plurality of key performance indicators for evaluating the application quality index for each of the one or more applications, wherein the plurality of key performance indicators is normalized in accordance to quality of the communication network of corresponding user of a plurality of users.

14. The computer system as recited in claim 10, further comprising predicting, at the quality quantification system, the application experience based on the quality of the communication network of corresponding user of the plurality of users, wherein the application experience enables each of a plurality of developers of the one or more applications for initiating suitable actions for enhancing the application experience.

15. The computer system as recited in claim 10, further comprising predicting, at the quality quantification system, user action based on the application experience for enabling each of the plurality of developers of the one or more applications for initiating the suitable actions for enhancing the application experience.

16. The computer system as recited in claim 10, further comprising enabling, at the quality quantification system, the plurality of developers to analyze the application experience of the plurality of users on the one or more applications, wherein the application experience depends on a plurality of factors, wherein the plurality of factors comprising signal strength, quality, transmission power, handover latency, Inter Radio Access Technologies, downlink throughput, uplink throughput, latency, packet loss, jitter, web latency of websites, and video latency from user end.

17. The computer system as recited in claim 10, further comprising recommending, at the quality quantification system, the suitable actions to the plurality of developers of the one or more applications for enhancing the application experience.

18. The computer system as recited in claim 10, further comprising aggregating, at the quality quantification system, the technical application data, the application business data, the user journey data and the user experience data based on one or more aspects, wherein the one or more aspects comprising application responsiveness, video streaming experience, video quality, audio quality, and transaction performance.

19. A non-transitory computer-readable storage medium encoding computer executable instructions that, when executed by at least one processor, performs a method for measuring application experience, the method comprising:
correlating, at a computing device, one or more applications, a communication network, and any of datacenter, cloud or content distribution network (CDN) logs in real-time;
receiving, at the computing device, an active testing data and a passive monitoring data associated with each of the one or more applications in real-time;
collecting, at the computing device, a technical application data and an application business data associated with each of the one or more applications in real-time;
fetching, at the computing device, a user journey data and a user experience data for each of the one or more applications in real-time;
analyzing, at the computing device, the active testing data, the passive monitoring data, the technical application data, the application business data, the user journey data and the user experience data using one or more machine learning algorithms, wherein the analysis is performed based on training of a machine learning model, wherein the analysis is performed in real time; and
evaluating, at the computing device, an application quality index based on the analysis of the active testing data, the passive monitoring data, the technical application data, the application business data, the user journey data and the user experience data.
